(19) United States
(12) Patent Application Publication
(10) Pub. No.: US 2021/0257159 A1
(43) Pub. Date: Aug. 19, 2021

(54) METHOD FOR PRODUCING WORKPIECE

(71) Applicant: TOYOTA JIDOSHA KABUSHIKI KAISHA, Toyota-shi (JP)

(72) Inventor: Noboru SHIMAMOTO, Toyota-shi (JP)

(73) Assignee: TOYOTA JIDOSHA KABUSHIKI KAISHA, Toyota-shi (JP)

(21) Appl. No.: 17/166,451

(22) Filed: Feb. 3, 2021

(30) Foreign Application Priority Data
Feb. 13, 2020 (JP) 2020-022396

(51) Int. Cl. H01F 41/02; H01F 1/153; H05B 6/06; H05B 6/10

(52) U.S. Cl. CPC H01F 41/0206; H01F 1/15333; H02K 15/00; H05B 6/101; H05B 6/06

(57) ABSTRACT

Provided is a method for producing a workpiece made of nano-crystal soft magnetic material, capable of efficiently producing a workpiece. The method sandwiches at least one metal sheet made of amorphous soft magnetic material between a punch and a die and punches the workpiece from the metal sheet to produce the workpiece. The method heats the punch to a crystallization starting temperature or higher at which the amorphous soft magnetic material crystallizes into nano-crystal soft magnetic material. The method includes a step of punching the workpiece from the metal sheet while heating the metal sheet with the punch and a step of crystallizing the amorphous soft magnetic material of the workpiece into nano-crystal soft magnetic material by making the workpiece after punched absorbed on the punch.

### CROSS REFERENCE TO RELATED APPLICATIONS

The present application claims priority from Japanese patent application JP 2020-022396 filed on Feb. 13, 2020, the entire content of which is hereby incorporated by reference into this application.

### BACKGROUND

### Technical Field

The present disclosure relates to a method for producing a workpiece from a metal sheet.

### Background Art

Conventional cores of motors and the like use nano-crystal soft magnetic material. The nano-crystal soft magnetic material is obtained by applying heat treatment to amorphous soft magnetic material at a crystallization starting temperature or higher. Since the nano-crystal soft magnetic material is brittle, performing punching after applying heat treatment to a metal sheet made of amorphous soft magnetic material may cause cracking and chipping of the metal sheet.

Then, there is proposed a method for producing a workpiece, including performing punching on a metal sheet made of amorphous soft magnetic material to form a workpiece, and then applying heat treatment to the workpiece to make the amorphous soft magnetic material of the workpiece crystallize into nano-crystal soft magnetic material (see WO2017/006868 for example).

### SUMMARY

However, when a workpiece is formed from a metal sheet made of amorphous soft magnetic material and then the workpiece is subjected to heat treatment, it is needed to apply heat treatment to the workpiece one by one. Unfortunately, this leads to low productivity.

In view of the foregoing, the present disclosure provides a method for producing a workpiece capable of efficiently producing a workpiece made of nano-crystal soft magnetic material.

In view of the foregoing, a method for producing a workpiece according to the present disclosure includes sandwiching at least one metal sheet made of amorphous soft magnetic material between a first tool and a second tool and punching a workpiece from the metal sheet, wherein at least one of the first tool and the second tool is a heated tool, the heated tool being heated to a crystallization starting temperature or higher at which the amorphous soft magnetic material crystallizes into nano-crystal soft magnetic material, and the method includes: a step of punching the workpiece from the metal sheet while heating the metal sheet with the heated tool; and a step of crystallizing the amorphous soft magnetic material of the workpiece into nano-crystal soft magnetic material by making the workpiece after punched adsorbed on the heated tool.

According to the present disclosure, in the punching step, while heating the metal sheet with the tool heated to the crystallization starting temperature or higher at which the material crystallizes into nano-crystal soft magnetic material, the method can punch the workpiece with the first tool and the second tool and thus can input the heat of the heated tool to the metal sheet. Herein, the punched workpiece may have warp or the like, but in the crystallization step, the method can remove the warp of the workpiece by making the punched workpiece adsorbed on the heated tool and continuously and uniformly input the heat of the heated tool to the workpiece.

As described above, since the workpiece made of nano-crystal soft magnetic material can be continuously heated by the heated tool throughout the punching step to the crystallization step, the method can efficiently produce the workpiece made of nano-crystal soft magnetic material. In addition, in the crystallization step, the method can discharge the heat of the workpiece from the side opposite to the side of the heated tool. This configuration can prevent the workpiece from being excessively heated by the heat generated by itself when the amorphous soft magnetic material crystallizes into nano-crystals and thus can obtain the workpiece made of nano-crystal soft magnetic material including uniform crystal grains.

Herein, examples of a method for bringing a metal sheet into close contact with a heated tool may providing a suction port in the heated tool and making the metal sheet adsorbed on the heated tool with suction from the suction port or providing a permanent magnet in the tool and making the metal sheet adsorbed on the tool with magnetic force by the permanent magnet.

However, in some embodiments, in the punching step, the workpiece is punched from the metal sheet while the metal sheet is adsorbed on the heated tool by energization of an electromagnetic coil disposed in the heated tool; in the crystallization step, adsorption of the workpiece on the heated tool is maintained by continuous energization of the electromagnetic coil; and after the crystallization step, adsorption of the workpiece on the heated tool is canceled by stopping energization of the electromagnetic coil.

According to this embodiment, in the crystallization step, the method can maintain the adsorption of the workpiece by energization of the electromagnetic coil, and after the crystallization step, the method can cancel the adsorption by stopping the energization of the electromagnetic coil. By adjusting the energization time and the energization timing of the electromagnetic coil, the method can adjust the time in which the workpiece is in close contact with the heated tool. Consequently, even if the workpiece generates heat by itself during crystallization of the workpiece, the method can easily control the temperature of the workpiece. Thus, the method can prevent the workpiece from being excessively heated and can make the crystallite size uniform.

Herein, as described above, when the suction port is provided in the tool to make the metal sheet adsorbed on the tool, heat of the heated tool is less likely to be transmitted to the portion of the metal sheet and the workpiece including the suction port. However, in this embodiment, use of the electromagnetic coil can bring the entire surface of the metal sheet into contact with the surface of the heated tool.

Meanwhile, as described above, when the permanent magnet is provided in the heated tool to make the metal sheet adsorbed on the tool, the tool always remains magnetized and thus continuously has, on its surface, adhering thereto particles generated during punching or the like. In this embodiment, however, even with the particles adhering to the tool surface, use of the electromagnetic coil can release the particles adhering to the tool surface by stopping the energization of the electromagnetic coil.

In some embodiments, in the punching step, a stack of metal sheets is sandwiched between the first tool and the second tool to punch a stack of workpieces from the stack of metal sheets; and in the crystallization step, the amorphous soft magnetic material of each one of the workpieces is crystallized while the stack of workpieces is adsorbed on the heated tool.

According to this embodiment, in the punching step, the plurality of workpieces in the stack can be punched simultaneously since the plurality of metal sheets in the stack are adsorbed with each other on the heated tool by the energization of the electromagnetic coil. In addition, in the crystallization step, the amorphous soft magnetic material of the plurality of workpieces can be crystallized simultaneously since the plurality of workpieces in the stack can be adsorbed on the heated tool by the continuous energization of the electromagnetic coil. The above-described steps can produce the plurality of workpieces simultaneously and increase the productivity of the workpieces.

In some embodiments, the method further includes a step of preheating the metal sheet at a temperature lower than the crystallization starting temperature before the punching step. Heating the metal sheet at a temperature lower than the crystallization starting temperature in the preheating step can reduce the time required for applying heat treatment to the metal sheet and the workpiece in the punching step and the crystallization step, and can efficiently perform the heat treatment.

According to the present disclosure, a workpiece made of nano-crystal soft magnetic material can be efficiently produced.

### BRIEF DESCRIPTION OF THE DRAWINGS

FIG. 1 is a schematic configuration view of a workpiece producing device that is used in a method for producing a workpiece according to a first embodiment of the present disclosure;

FIG. 2 is a graph showing the change in temperature of a metal sheet when producing the workpiece according to the first embodiment;

FIG. 3A is a schematic cross-sectional view for explaining a punching step performed by the producing device shown in FIG. 1;

FIG. 3B is a schematic cross-sectional view for explaining a crystallization step after the punching step performed by the producing device shown in FIG. 1;

FIG. 3C is a view for explaining a state where a contact state of a workpiece is cancelled after the crystallization step ends as shown in FIG. 2;

FIG. 4 is a schematic cross-sectional view for explaining the crystallization step after the punching step in another producing method performed by the producing device shown in FIG. 3B;

FIG. 5 is a schematic configuration view of a workpiece producing device that is used in a method for producing a workpiece according to a second embodiment of the present disclosure;

FIG. 6 is a schematic cross-sectional view for explaining a crystallization step after a punching step performed by the producing device shown in FIG. 5; and

FIG. 7 is a view for explaining a crystallization step in another producing method shown in FIG. 6.

### DETAILED DESCRIPTION

The following describes a method for producing a workpiece according to an embodiment of the present disclosure.

### First Embodiment

1. Producing Device 1A

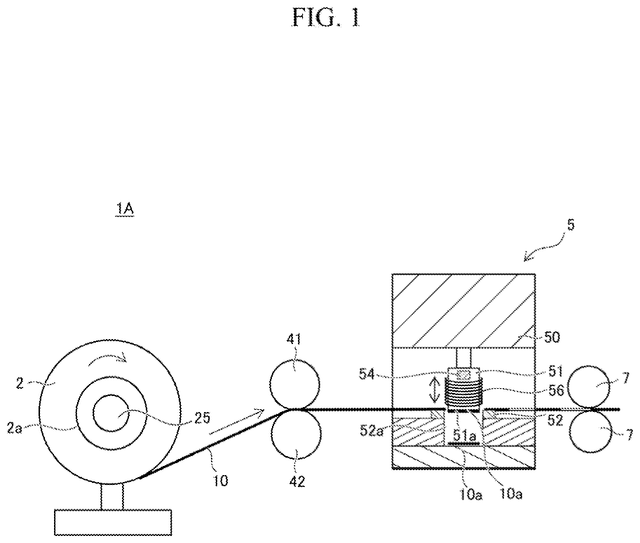

Firstly the following describes a producing device 1A that is used in a method for producing a workpiece 10a according to a first embodiment of the present disclosure with reference to FIG. 1.

The producing device 1A includes a delivery device 2 to deliver a metal sheet 10 of a strip, which is an initial material of the workpiece 10a, tension rolls 41, 42 to apply tension to the metal sheet 10, and a punch press 5 to perform punching on the metal sheet 10. The producing device 1A also includes a pair of discharge rolls 7, 7 to discharge from the punch press 5 the metal sheet 10 after punching in the back side (in the downstream side) of the punch press 5 in a delivery direction. The producing device 1A further includes a winding device (not illustrated) to wind into a roll the metal sheet 10 after punching the workpiece 10a in the downstream side of the pair of discharge rolls 7, 7. This configuration can deliver the metal sheet 10 from the delivery device 2 to the winding device.

The delivery device 2 includes a shaft portion 2a, around which the metal sheet 10 in a coil shape is wound. The delivery device 2 can deliver the metal sheet 10 toward the punch press 5 by rotating the shaft portion 2a. The delivery device 2 includes a heater 25 to heat the metal sheet 10.

Specifically, the heater 25 is embedded in the shaft portion 2a and configured to heat the shaft portion 2a at a crystallization starting temperature or lower, which will be described later. Heating the shaft portion 2a with the heater 25 can preheat the metal sheet 10 before punching to a predetermined temperature via the shaft portion 2a. Although the heater 25 is provided in the shaft portion 2a of the delivery device 2 in the present embodiment, a heater may be provided so as to heat the metal sheet 10 from the outer surface, for example.

The tension rolls 41, 42 that apply a predetermined tension to the metal sheet 10 are provided between the delivery device 2 and the punch press 5. The tension rolls 41, 42 can deliver the metal sheet 10 to the punch press 5 while applying a predetermined tension to the metal sheet 10.

The punch press 5 includes a device body 50, which includes a punch 51 and a die 52 disposed below the punch 51. The punch 51 has a punching face 51a according to the shape of the workpiece 10a. The punching face 51a has a shape of a rotor core of a motor, for example. The die 52 has a recess 52a according to the shape of the punching face 51a of the punch 51. When punching, the punch 51 is inserted into the recess 52a of the die 52.

The punch 51 can move up and down with respect to the die 52 by the device body 50 including a hydraulic machine or the like (not illustrated). This configuration can sandwich the metal sheet 10 between the punch 51 and the die 52 and punch the workpiece 10a from the metal sheet 10.

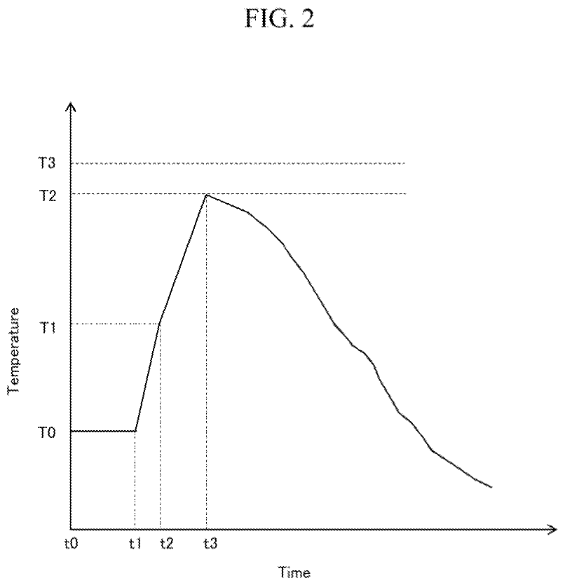

In addition, the punch 51 includes a heater 54 to heat the punch 51. The heater 54 is configured to heat the punch 51 to a temperature higher than or equal to a temperature (crystallization starting temperature) T1 at which amorphous soft magnetic material crystallizes into nano-crystal soft magnetic material, which will be described later (see FIG. 2). This configuration can crystallize the workpiece 10a obtained by punching from the metal sheet 10 into a desired crystal condition by the heat from the punch 51 heated to the crystallization starting temperature T1 or higher (specifically, a heating temperature T3) in a crystallization step (described later).

It should be noted that the terms punch 51 and die 52 as used in the present embodiment correspond to “first tool and second tool” of the present disclosure. Since the punch 51 is heated by the heater 54, the term punch 51 as used in the present embodiment corresponds to “heated tool” of the present disclosure. Although the punch 51 is heated by the heater 54 in the present embodiment, the die 52 may be heated by another heater, for example.

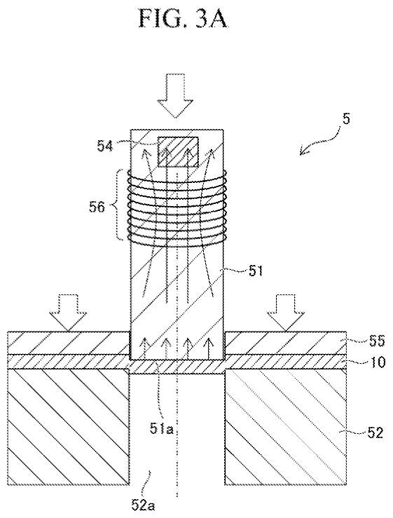

As shown in FIG. 3A, the punch press 5 includes a pressing member 55 that moves up and down with respect to the die 52 together with the punch 51 and presses the metal sheet 10 toward the die 52 when punching. It should be noted that the pressing member 55 is omitted in FIG. 1. The heat by the heater 54 will not be directly transmitted to the pressing member 55. The configuration of the punch press 5 including the punch 51, the die 52, the pressing member 55, and the like is the same as that of a typical punch press. Thus, the detailed description of the structure and mechanism of the punch press 5 will be omitted herein.

The punch 51 includes an electromagnetic coil 56, which is connected to a power source (not illustrated) via a switch (not illustrated) or the like. Turning on/off the switch can control electric current to be supplied or not to be supplied to the electromagnetic coil 56 from the power source. That is, when the electric current is supplied to the electromagnetic coil 56, the electromagnetic coil 56 is energized, whereas when current supply stops, energization of the electromagnetic coil 56 stops (energization is cancelled).

2. Metal Sheet 10

The metal sheet 10 prepared in the present embodiment is a metal sheet made of amorphous soft magnetic material. The workpiece 10a produced from the metal sheet 10 is a sheet member made of nano-crystal soft magnetic material. In the producing method described below, the workpiece 10a obtained by punching from the metal sheet 10 made of amorphous soft magnetic material is subjected to heat treatment so that amorphous soft magnetic material crystallizes into nano-crystal soft magnetic material. These materials will be descried below.

Now, the amorphous soft magnetic material forming the metal sheet 10 and the nano-crystal soft magnetic material forming the workpiece 10a will be described. Examples of the amorphous soft magnetic material and nano-crystal soft magnetic material include, but are not limited to, material containing at least one magnetic metal selected from the group consisting of Fe, Co, and Ni and at least one non-magnetic metal selected from the group consisting of B, C, P, Al, Si, Ti, V, Cr, Mn, Cu, Y, Zr, Nb, Mo, Hf, Ta, and W.

Typical examples of the amorphous soft magnetic material and nano-crystal soft magnetic material include, but are not limited to, a FeCo-based alloy (e.g., FeCo and FeCoV), a FeNi-based alloy (e.g., FeNi, FeNiMo, FeNiCr, and FeNiSi), a FeAl-based alloy or a FeSi-based alloy (e.g., FeAl, FeAlSi, FeAlSiCr, FeAlSiTiRu, and FeAlO), a FeTa-based alloy (e.g., FeTa, FeTaC, and FeTaN) and a FeZr-based alloy (e.g., FeZrN). The Fe-based alloy may contain at least 80 at % of Fe.

As another example of the amorphous soft magnetic material and nano-crystal soft magnetic material, a Co-based alloy containing Co and at least one of Zr, Hf, Nb, Ta, Ti, or Y may be used. The Co-based alloy may contain at least 80 at % of Co. Such a Co-based alloy is likely to become an amorphous state when it is deposited as a film, and exhibits excellent soft magnetism because it has small magnetocrystalline anisotropy and few crystal defects and grain boundaries. Examples of the amorphous soft magnetic material include CoZr, CoZrNb, and CoZrTa-based alloys.

The amorphous soft magnetic material as used herein is soft magnetic material having an amorphous structure as a main structure. In the amorphous structure, no clear peak appears in an X-ray diffraction pattern, and only a broad halo pattern can be observed. Meanwhile, a nano-crystal structure can be formed by applying heat treatment to the amorphous structure, and in a nano-crystal soft magnetic material having a nano-crystal structure, a diffraction peak can be observed in a position corresponding to a gap between lattice points on the crystal plane. Based on the width of the diffraction peak, the crystallite size can be calculated with the Scherrer equation.

In the nano-crystal soft magnetic material as used herein, each nano-crystal has a crystallite size of less than 1 μm as calculated with the Scherrer equation based on the full width at half maximum (FWHM) of a diffraction peak of an X-ray diffraction pattern. In the present embodiment, the crystallite size of each nano-crystal (the crystallite size as calculated with the Scherrer equation based on the full width at half maximum (FWHM) of a diffraction peak of an X-ray diffraction) may be equal to or less than 100 nm, or equal to or less than 50 nm. In addition, the crystallite size of each nano-crystal may be equal to or greater than 5 nm. If nano-crystals have a crystallite size within such a range, magnetic properties can be improved. Meanwhile, the crystallite size of a conventional electromagnetic steel sheet is of the order of μm, and typically equal to or greater than 50 μm.

The amorphous soft magnetic material can be obtained by, for example, melting metal material, which has been prepared to have the above-mentioned composition, at a high temperature in a high-frequency melting furnace or the like to obtain a uniform molten metal and quenching the result. The quenching rate is, for example, about 10⁶° C./sec, though it depends on the material used. However, the quenching rate is not particularly limited as long as an amorphous structure can be obtained before the material crystallizes. In the present embodiment, the metal sheet as will be described later can be obtained by blowing the molten metal of the metal material onto a rotating cooling roll to produce a metal sheet strip made of amorphous soft magnetic material and winding the metal sheet strip into a roll. In this manner, quenching a molten metal can obtain soft magnetic material having an amorphous structure before the material crystallizes. The metal sheet 10 may have a thickness not less than 10 μm and not greater than 100 μm, for example, and particularly not less than 20 μm and not greater than 50 μm.

Next, the method for producing the workpiece 10a using the producing device 1A will further be described with reference to FIG. 3A to FIG. 3C.

(Preheating Step)

Firstly the method performs a preheating step on the metal sheet 10. Specifically, as shown in FIG. 1, the heater 25 heats the metal sheet 10 to a temperature (preheat temperature) T0 that is lower than the crystallization starting temperature T1 at which crystallization of amorphous soft magnetic material begins (see time t0 in FIG. 2).

(Punching Step)

Next, the method performs a punching step on the preheated metal sheet 10. Specifically, the preheated metal sheet 10 delivered from the delivery device 2 via the tension rolls 41, 42 is sandwiched between the punch 51 and the die 52 of the punch press 5 to punch the workpiece 10a having a predetermined shape. At this time, the punch 51, which is heated to the crystallization starting temperature T1 (specifically, heating temperature T3) or higher at which amorphous soft magnetic material crystallizes into nano-crystal soft magnetic material, punches the workpiece 10a while heating the metal sheet 10. Specifically, the heater 54 sets the heating temperature T3 of the punch 51 to a temperature higher than a temperature (target temperature) T2 at which the temperature rise of the workpiece 10a ends, that is, a temperature of 500° C., for example.

In this punching step, the electromagnetic coil 56 is energized by being supplied with electric current. It should be noted that as shown in FIG. 3A, the metal sheet 10 does not move toward the electromagnetic coil 56 before punching since the metal sheet 10 is pressed by the pressing member 55 with the die 52. However, as long as the method can energize the electromagnetic coil 56 at a timing at which the punch 51 comes into contact with the metal sheet 10 and can precisely perform punching from the metal sheet 10 when punching, the pressing member 55 may be omitted.

The metal sheet 10 is made of soft magnetic material, and thus as shown in FIG. 3A, when punching, the portion of the metal sheet 10 being in contact with the punching face 51a of the punch 51 is adsorbed on the punch 51 by the energization of the electromagnetic coil 56. This configuration can heat the metal sheet 10 and punch the workpiece 10a from the metal sheet 10 while making the metal sheet 10 adsorbed on the punch 51, and can maintain the adsorption of the workpiece 10a even after punching.

Herein, the metal sheet 10 may reach the crystallization starting temperature T1 in the state shown in FIG. 3A (that is, during plastic deformation of the metal sheet 10 while punching), but alternatively, the metal sheet 10 may reach the crystallization starting temperature T1 in an advanced state from the state shown in FIG. 3A, for example, when the punching ends (i.e., at a timing when the workpiece 10a is formed or thereafter). This configuration can complete the punching before the metal sheet 10 crystallizes into nano-crystals with a desired grain size, that is, before the metal sheet 10 becomes brittle. It should be noted that after the workpiece 10a reaches the crystallization starting temperature Ti, the temperature of the workpiece 10a tends to rise due to heat generated by itself during crystallization. It should be noted that after this punching step, crystallization of the workpiece 10a is not completed yet.

(Crystallization Step)

Next, the method performs a crystallization step on the workpiece 10a. Specifically, as shown in FIG. 3B, amorphous soft magnetic material of the workpiece 10a is made crystallize into nano-crystal soft magnetic material while making the workpiece 10a punched by the punch 51 adsorbed on the punch 51 (heated tool). Specifically, with continuous energization of the electromagnetic coil 56, the adsorption of the workpiece 10a on the punching face 51a of the punch (heated tool) 51 is maintained.

At this time, the temperature of the workpiece 10a further rises by the heat of reaction along with crystallization and the heat from the punch 51. In this way, the method can complete the crystallization of amorphous soft magnetic material into nano-crystal soft magnetic material by retaining the temperature of the workpiece 10a (i.e., by subjecting the workpiece 10a to heat treatment) at the crystallization starting temperature T1 or higher (further, at the heating temperature T3 or lower of the punch 51) by the punch 51.

Typically, the nano-crystal soft magnetic material can be obtained by heating the amorphous soft magnetic material for crystallization (modification). That is, the amorphous structure of the soft magnetic material turns to a nano-crystal structure by the heat treatment. In the present embodiment, the heat treatment in the punching step and the crystallization step causes the amorphous soft magnetic material to crystallize into nano-crystal soft magnetic material.

The conditions of heat treatment for crystallization of amorphous soft magnetic material into nano-crystal soft magnetic material are not particularly limited, and may be appropriately selected in consideration of the composition of metal material and the desired magnetic properties to be obtained, for example. Therefore, the temperature of the heat treatment (specifically, the temperature T3 of the punch 51) is higher than the crystallization starting temperature of the amorphous soft magnetic material, though not particularly limited thereto. Accordingly, performing heat treatment allows the amorphous soft magnetic material to crystallize into nano-crystal soft magnetic material. The heat treatment may be performed in an inert gas atmosphere.

The crystallization starting temperature is a temperature at which crystallization occurs. Since exothermic reaction occurs during crystallization, the crystallization starting temperature may be determined by measuring the temperature at which heat is generated along with the crystallization. For example, the crystallization starting temperature can be measured under the condition of a predetermined heating rate (e.g., 0.67 Ks⁻¹) using differential scanning calorimetry (DSC). The crystallization starting temperature T1 of amorphous soft magnetic material is, for example, from 300 to 500° C., though it differs depending on the material used. Therefore, the preheat temperature T0 in the preheating step is lower than the crystallization starting temperature T1 (for example, 250 to 350° C., a temperature at which crystallization does not begin). Similarly, the temperature at which nano-crystal soft magnetic material further crystallizes can also be measured using differential scanning calorimetry (DSC). Although nano-crystal soft magnetic material already has crystals generated therein, crystallization further progresses if the nano-crystal soft magnetic material is heated to the crystallization starting temperature or higher.

The heating temperature T3 of the punch 51 at which amorphous soft magnetic material is made crystallize into nano-crystal soft magnetic material is not particularly limited as long as it is equal to or higher than the crystallization starting temperature T1 at which amorphous soft magnetic material crystallizes into nano-crystal soft magnetic material. For example, in the case of an iron-based amorphous alloy, the heating temperature T3 may be equal to or higher than 350° C., or equal to or higher than 400° C. Setting the heating temperature to 400° C. or higher allows crystallization to progress efficiently. Further, the heating temperature may be equal to or lower than 600° C., or equal to or lower than 520° C., for example. Setting the heating temperature to 520° C. or lower can more easily avoid excessive crystallization and suppress generation of by-products (for example, Fe₂B). The heating time for the crystallization step is not particularly limited, but may be not shorter than 1 second and not longer than 10 minutes, or not shorter than 1 second and not longer than 5 minutes.

(Adsorption-Cancel Step)

As shown in FIG. 3C, the method cancels the adsorption of the workpiece 10a on the punch 51. Specifically, after the crystallization step, the energization of the electromagnetic coil 56 is stopped, so that the adsorption of the workpiece 10a on the heated punch 51 is cancelled. Herein, as for the cancellation timing, the adsorption of the workpiece 10a is cancelled so that the workpiece 10a reaches the target temperature T2, for example. After the workpiece 10a reaches the target temperature T2, the temperature of the workpiece 10a will not rise but decrease. Thus, the workpiece 10a is cooled after the workpiece 10a reaches the temperature T2 at which the crystallization ends.

In the present embodiment, the cancellation timing of the energization of the electromagnetic coil 56 can be set on the basis of the heating rate by the punch 51, the heat generation rate of the workpiece 10a that generates heat by itself, and the heat release rate of the workpiece 10a, for example. Specifically, if the workpiece 10a reaches the target temperature T2 at time t3, the energization of the electromagnetic coil 56 may be stopped at time t2.

Although not shown in FIG. 2, as long as the temperature of the workpiece 10a can be retained within a predetermined temperature range from the target temperature T2 for a certain time, the energization of the electromagnetic coil 56 may be stopped after the temperature of the workpiece 10a is retained within the temperature range for a certain time. In addition, since the workpiece 10a generates heat by itself at the crystallization starting temperature T1 or higher, when the heat generation rate of the heat generated by itself is great, the adsorption of the workpiece 10a may be cancelled between time t2 to time t3, and then the temperature of the workpiece 10a may reach the target temperature T2 by the heat generated by itself at time t3.

(Cooling Step)

When the energization of the electromagnetic coil 56 is stopped and the adsorption of the workpiece 10a on the punch 51 is cancelled in the adsorption-cancel step, the workpiece 10a is separated from the punch 51. The workpiece 10a moves downward under its own weight and the workpiece 10a is cooled (at time t3 or thereafter in FIG. 2). Herein, the workpiece 10a may be gradually cooled by cooling, but may be cooled by forced cooling, for example. This configuration can sequentially produce the workpiece 10a made of nano-crystal soft magnetic material while delivering the metal sheet 10 and discharge the metal sheet 10 after punching from the punch press 5 via the pair of discharge rolls 7, 7.

In the punching step, while heating the metal sheet 10 with the punch 51 heated to the crystallization starting temperature T1 or higher at which the material crystallizes into nano-crystal soft magnetic material, the present embodiment can punch the workpiece 10a with the punch 51 and the die 52 and thus can input the heat of the punch 51 to the metal sheet 10. Herein, the punched workpiece 10a may have warp or the like, but in the crystallization step, the present embodiment can remove the warp of the workpiece 10a by making the punched workpiece 10a adsorbed on the punch 51 and also bring the workpiece 10a into close contact with the punch 51 to continuously and uniformly input the heat of the punch 51 to the workpiece 10a.

As described above, since the workpiece 10a made of nano-crystal soft magnetic material can be continuously heated by the punch 51 throughout the punching step to the crystallization step, the present embodiment can efficiently produce the workpiece 10a made of nano-crystal soft magnetic material. In addition, in the crystallization step, the present embodiment can discharge the heat of the workpiece 10a from the side opposite to the side of the punching face 51a of the punch 51. This configuration can prevent the workpiece 10a from being excessively heated by the heat generated by itself when the amorphous soft magnetic material crystallizes into nano-crystals and thus can obtain the workpiece 10a made of nano-crystal soft magnetic material including uniform crystal grains.

In the crystallization step, the present embodiment can maintain the adsorption of the workpiece 10a by energization of the electromagnetic coil 56, and after the crystallization step, cancel the adsorption by stopping the energization of the electromagnetic coil 56. By adjusting the energization time and the energization timing of the electromagnetic coil 56, the present embodiment can adjust the time (that is, the heating time) in which the workpiece 10a is adsorbed on the heated punch 51. Consequently, even if the workpiece 10a generates heat by itself during crystallization of the workpiece 10a, the present embodiment can easily control the temperature of the workpiece 10a. Thus, the present embodiment can prevent the workpiece 10a from being excessively heated and can make the crystallite size uniform.

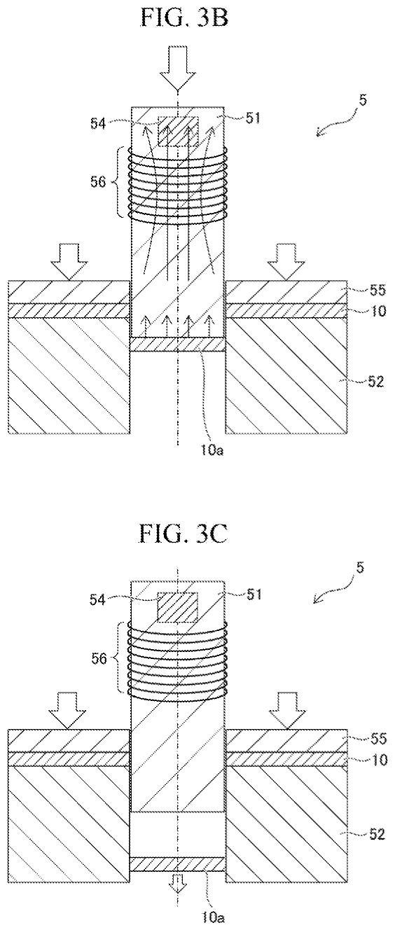

In the embodiment shown in FIG. 1 to FIG. 3C, the workpiece 10a is produced from one piece of metal sheet 10. However, as shown in FIG. 4, for example, a plurality of workpieces 10a, 10a, . . . may be produced from a plurality of metal sheets 10, 10, . . . according to the number of metal sheets. In such a modification, specifically in the punching step, a stack of the plurality of metal sheets 10, 10, . . . is sandwiched between the punch 51 and the die 52, and a stack of the plurality of workpieces 10a, 10a, . . . is punched from the plurality of metal sheets 10, 10, . . . . At this time, the electromagnetic coil 56 is energized to magnetize the punch 51. The metal sheets 10, 10, . . . in the stack are adsorbed with each other, so that the plurality of workpieces 10a, 10a, . . . in the stack can be punched simultaneously.

In this way, in the crystallization step, the stack of the plurality of workpieces 10a, 10a, . . . is adsorbed on the punch 51 to crystallize the amorphous soft magnetic material of each one of the workpieces 10a, 10a, . . . . In the present embodiment, since the electromagnetic coil 56 is continuously energized, the punch 51 also remains magnetized. Thus, the adsorption state of the workpieces 10a, 10a, . . . immediately after the punching step is maintained. In the crystallization step, the electromagnetic coil 56 is continuously energized, so that the stack of the plurality of workpieces 10a, 10a, . . . can be adsorbed on the punch 51. This can heat the plurality of workpieces 10a, 10a, . . . to the crystallization starting temperature T1 or higher and crystallize them simultaneously.

Thereafter, the energization of the electromagnetic coil 56 is stopped (i.e., adsorption is cancelled) so that the workpieces 10a, 10a, . . . reach the target temperature T2, and the workpieces 10a, 10a, . . . are cooled. The above-described steps can produce the plurality of workpieces 10a, 10a, . . . simultaneously and increase the productivity of the workpieces 10a, 10a, . . . .

### Second Embodiment

The following describes a method for producing a workpiece 10a using a producing device 1B according to a second embodiment. The main differences from the first embodiment are the arrangement of the tension rolls 41, 42 and the use of a rotary die cutter 6 instead of the punch press 5. Description of the configuration having the same function as in the first embodiment will be omitted.

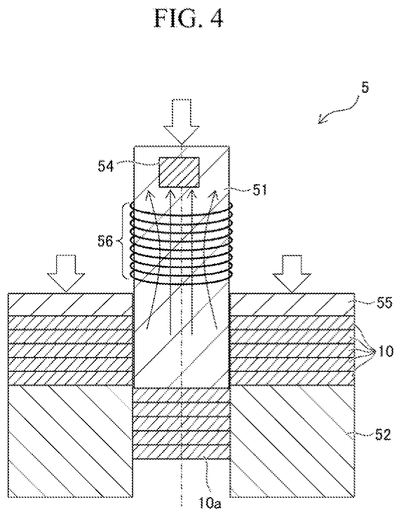

The rotary die cutter 6 is made up of a die roll 61 and an opposing roll 62 disposed opposite to the die roll 61. The die roll 61 and the opposing roll 62 are formed to extend in a width direction (i.e., vertical to the paper surface of FIG. 5) perpendicular to the delivery direction of the metal sheet 10 and disposed parallel to each other. Each of the die roll 61 and the opposing roll 62 rotates with a drive force from a drive device (not illustrated) and delivers the metal sheet 10 in the downstream side (to the right in FIG. 5).

The die roll 61 includes a columnar roll body 61a and cutting portions 61b, which are provided on the peripheral surface of the roll body 61a and protrude outwardly in the radial direction. The cutting portions 61b are formed in a predetermined shape (for example, in a circular shape) as viewed outwardly from the radial direction of the roll body 61a. Rotating the die roll 61 and the opposing roll 62 allows the cutting portions 61b of the die roll 61 to perform punching on the metal sheet 10, thereby forming the workpiece 10a in a predetermined shape (for example, in a circular shape).

The die roll 61 and the opposing roll 62 include a heater 64 and a heater 65, respectively. The heaters 64, 65 are configured to respectively heat the die roll 61 and the opposing roll 62 to the above-described crystallization starting temperature T1 or higher. As in the first embodiment, the present embodiment can crystallize the workpiece 10a obtained by punching from the metal sheet 10 into a desired crystal condition by the heat from the die roll 61 and the opposing roll 62 heated to the crystallization starting temperature T1 or higher (specifically, a temperature T3) in the crystallization step.

It should be noted that the terms die roll 61 and opposing roll 62 as used in the present embodiment correspond to “first tool and second tool” of the present disclosure. Since the opposing roll 62 is heated until the workpiece 10a crystallizes, the term opposing roll 62 as used in the present embodiment corresponds to “heated tool” of the present disclosure. Although the die roll 61 is also heated by the heater 64 in the present embodiment, as long as the workpiece 10a can crystallize by the opposing roll 62, the die roll 61 may not be provided with the heater 64, for example.

The opposing roll 62 includes a plurality of electromagnetic coils 66 in its circumferential direction, which are connected to a power source (not illustrated) via a switch (not illustrated) or the like. Turning on/off the switch can control electric current to be supplied or not to be supplied to the electromagnetic coils 66 from the power source. That is, when the electric current is supplied to the electromagnetic coils 66, the electromagnetic coils 66 are energized, whereas when current supply stops, energization of the electromagnetic coils 66 stops (energization is cancelled).

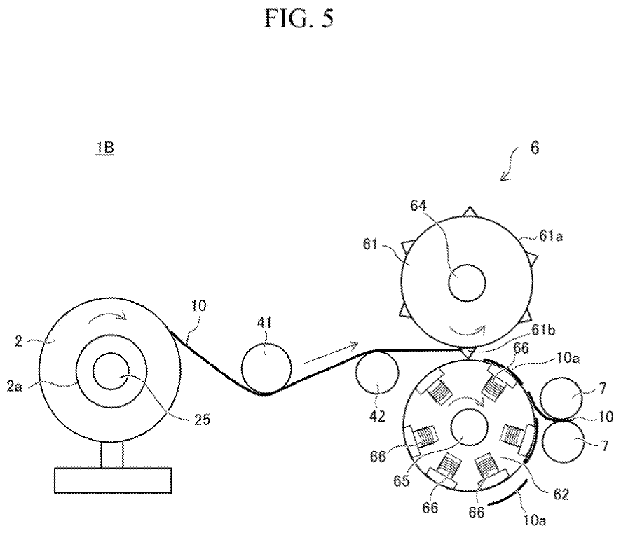

Specifically, as shown in FIG. 6, the opposing roll 62 includes a housing recess 62a that houses the electromagnetic coil 66 in its circumferential direction. The electromagnetic coil 66 is wound around an iron core 62b made of soft magnetic material. The housing recess 62a has fixed thereto a cover 62c having a curved surface according to the peripheral surface of the opposing roll 62. The cover 62c may be made of the same material as the peripheral surface of the opposing roll 62 (specifically, the opposing roll body). This can make the thermal conductivity of the cover 62c by the heater 65 equal to that of the opposing roll 62 to make the temperature of the surface of the opposing roll 62 uniform.

When the workpiece 10a is produced using the producing device 1B, the metal sheet 10 is heated to the preheat temperature T0 that is lower than the crystallization starting temperature T1. Next, the preheated metal sheet 10 delivered from the delivery device 2 via the tension rolls 41, 42 is sandwiched between the die roll 61 and the opposing roll 62 to punch the workpiece 10a having a predetermined shape. At this time, by sandwiching the metal sheet 10 between the die roll 61 and the opposing roll 62 which are heated to the crystallization starting temperature T1 or higher, the workpiece 10a is punched while the metal sheet 10 is heated. At this time, the workpiece 10a is punched from the metal sheet 10 while the electromagnetic coil 66 disposed in the opposing roll 62 is energized and the metal sheet 10 is made adsorbed on the opposing roll 62.

The workpiece 10a is adsorbed on the opposing roll 62 by the energization of the electromagnetic coil 66. This configuration can heat the metal sheet 10 and punch the workpiece 10a from the metal sheet 10 while making the metal sheet 10 adsorbed on the opposing roll 62, and can maintain the adsorption state of the workpiece 10a even after punching.

In addition, in the crystallization step, amorphous soft magnetic material of the workpiece 10a is made crystallize into nano-crystal soft magnetic material while making the workpiece 10a adsorbed on the opposing roll 62 (heated tool). Specifically, with continuous energization of the electromagnetic coil 66, the adsorption of the workpiece 10a on the opposing roll 62 is maintained. The present embodiment can remove the warp of the workpiece 10a and also bring the workpiece 10a in close contact with the opposing roll 62 to continuously and uniformly input the heat of the opposing roll 62 to the workpiece 10a.

In the crystallization step, one of the opposite surfaces of the workpiece 10a is in contact with the opposing roll 62 and the other surface of the workpiece 10a is not in contact with a heat source or the like. Thus, the heat of the workpiece 10a can be discharged from the other surface of the workpiece 10a.

Furthermore, when the workpiece 10a moves downward below the opposing roll 62 after the crystallization step, the adsorption of the workpiece 10a on the opposing roll 62 is cancelled by stopping the energization of the electromagnetic coil 66. As for the specific timing of cancelling adsorption, the adsorption of the workpiece 10a is cancelled after the workpiece 10a reaches the target temperature T2, for example, on the assumption that workpiece 10a moves downward. When the energization of the electromagnetic coil 66 is stopped and the adsorption of the workpiece 10a on the opposing roll 62 is cancelled, the workpiece 10a is separated from the opposing roll 62. The workpiece 10a moves downward under its own weight and the workpiece 10a is cooled.

Since the punching step and the heat treatment step can be performed by the same rotary die cutter 6, the present embodiment can efficiently produce the workpiece 10a made of nano-crystal soft magnetic material.

Although the cutting portions 61b of the rotary die cutter 6 are not capable of instantly applying a large amount of heat to the metal sheet 10, providing the preheating step to heat the metal sheet 10 can easily heat the metal sheet 10 to the crystallization starting temperature T1 or higher. It should be noted that the use of the rotary die cutter 6 can complete punching before the metal sheet 10 becomes brittle along with the proceeding of crystallization, and thus the metal sheet 10 is free from cracking and chipping.

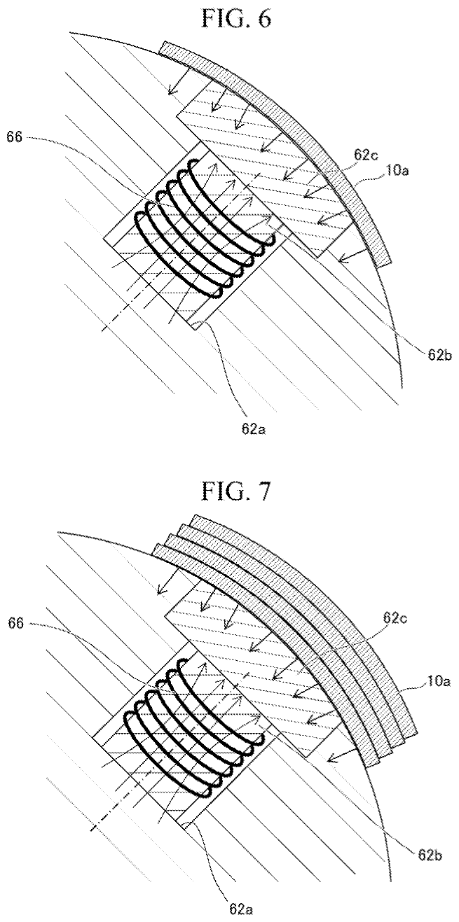

The present embodiment produces the workpiece 10a from one piece of metal sheet 10. However, as shown in FIG. 7, for example, a plurality of workpieces 10a, 10a, . . . may be produced from a plurality of metal sheets 10, 10, . . . according to the number of metal sheets. In such a modification, specifically in the punching step, a stack of the plurality of metal sheets 10, 10, . . . is sandwiched between the die roll 61 and the opposing roll 62, and a stack of the plurality of workpieces 10a, 10a, . . . is punched from the plurality of metal sheets 10, 10, . . . . At this time, the electromagnetic coils 66 are energized to magnetize the opposing roll 62. The metal sheets 10, 10, . . . in the stack are adsorbed with each other, so that the plurality of workpieces 10a, 10a, . . . in the stack can be punched simultaneously.

In this way, in the crystallization step, the stack of the plurality of workpieces 10a, 10a, . . . is adsorbed on the opposing roll 62 to crystallize the amorphous soft magnetic material of each one of the workpieces 10a, 10a, . . . . In the present embodiment, since the electromagnetic coils 66 are continuously energized, the opposing roll 62 also remains magnetized. Thus, the adsorption state of the workpieces 10a, 10a, . . . immediately after the punching step is maintained. In the crystallization step, the stack of the plurality of workpieces 10a, 10a, . . . can be adsorbed on the opposing roll 62 by continuous energization of the electromagnetic coils 66. This can heat the plurality of workpieces 10a, 10a, . . . to the crystallization starting temperature T1 or higher and crystallize them simultaneously.

Thereafter, the energization of the electromagnetic coils 66 is stopped (i.e., adsorption is cancelled) so that the workpieces 10a, 10a, . . . reach the target temperature T2, and the workpieces 10a, 10a, . . . are cooled. The above-described steps can produce the plurality of workpieces 10a, 10a, . . . simultaneously and increase the productivity of the workpieces 10a, 10a, . . . .

While the embodiments of the present disclosure have been described in detail above, the present disclosure is not limited thereto, and can be subjected to various kinds of changes of design without departing from the spirit and scope of the present disclosure described in the claims.

For example, although the example of providing a heater in the delivery device to preheat the metal sheet is described in the first and second embodiments, a heater for preheating may be provided in a tension roll, for example.

In addition, although the punch is vertically moved and the punching face faces down in the first embodiment, as long as punching by a punch and adsorption of a workpiece can be performed, the moving direction of the punch and the direction of the punching face are not particularly limited.

In the first and second embodiments, the electromagnetic coil is used to make the metal sheet and the workpiece absorbed on the punch or the opposing roll corresponding to the heated tool. However, for example, the metal sheet and the workpiece may be adsorbed with a negative pressure generated at a suction port, or the metal sheet and the workpiece may be adsorbed by a permanent magnet instead of the electromagnetic coil.

What is claimed is:

1. A method for producing a workpiece, the method including sandwiching at least one metal sheet made of amorphous soft magnetic material between a first tool and a second tool and punching a workpiece from the metal sheet, wherein at least one of the first tool and the second tool is a heated tool, the heated tool being heated to a crystallization starting temperature or higher at which the amorphous soft magnetic material crystallizes into nano-crystal soft magnetic material, the method comprising:
a step of punching the workpiece from the metal sheet while heating the metal sheet with the heated tool; and
a step of crystallizing the amorphous soft magnetic material of the workpiece into nano-crystal soft magnetic material by making the workpiece after punched adsorbed on the heated tool.

2. The method for producing a workpiece according to claim 1,
wherein:
in the punching step, the workpiece is punched from the metal sheet while the metal sheet is adsorbed on the heated tool by energization of an electromagnetic coil disposed in the heated tool;
in the crystallization step, adsorption of the workpiece on the heated tool is maintained by continuous energization of the electromagnetic coil; and
after the crystallization step, adsorption of the workpiece on the heated tool is canceled by stopping energization of the electromagnetic coil.

3. The method for producing a workpiece according to claim 2,
wherein:
in the punching step, a stack of metal sheets is sandwiched between the first tool and the second tool to punch a stack of workpieces from the stack of metal sheets; and
in the crystallization step, the amorphous soft magnetic material of each one of the workpieces is crystallized while the stack of workpieces is adsorbed on the heated tool.

4. The method for producing a workpiece according to claim 1, further comprising a step of preheating the metal sheet at a temperature lower than the crystallization starting temperature before the punching step.
